(19) United States
(12) Patent Application Publication
(10) Pub. No.: US 2017/0323377 A1
(43) Pub. Date: Nov. 9, 2017

(54) Method of raising capital via a business entity with a contract to generate revenue for the entity

(71) Applicant: Jane Koo, San Francisco, CA (US)

(72) Inventor: Jane Koo, San Francisco, CA (US)

(21) Appl. No.: 15/149,254

(22) Filed: May 9, 2016

(51) Int. Cl. G06Q 30/06; G06Q 50/12

(52) U.S. Cl. CPC G06Q 30/0645; G06Q 50/12; G06Q 2230/00

(57) ABSTRACT

A method of raising capital including the steps of: providing a business entity; providing an entity officer responsible for the operation and day-to-day decision-making of the entity; selling all or part of the original owner's interest in a business (e.g. a restaurant) or property (e.g. a residential house) to the entity, providing a contract based on the business or property (e.g. a restaurant operating contract or a residential lease) to generate revenue for the entity; raising equity and/or debt capital issued by the entity from investors to fund the entity's purchase of the original owner's interest; and providing an investor-voting system so a voting majority of investors can potentially replace the entity officer.

### FIELD OF THE INVENTION

The present invention generally relates to systems and methods for raising capital for a business or property, and in particular to systems and methods for providing a business entity, providing an entity officer responsible for the operation and day-to-day decision-making of the entity; selling all or part of the original owner's interest in the business or property to the entity; providing a contract based on the business or property to generate revenue for the entity, raising equity and/or debt capital issued by the entity from investors to fund the entity's purchase of the original owner's interest; and providing an investor-voting system so a voting majority of investors can potentially replace the entity officer.

### BACKGROUND OF THE INVENTION

As a means to raise capital for a business (e.g. a restaurant) or property (e.g. a residential house), the original owner of the business or property may seek equity and/or debt investors, or may seek a counterparty to whom to sell all or part of the original owner's interest in the business or property and then set up a contract involving the original owner (e.g. the original owner will operate the restaurant or the original owner will be the tenant of the residential lease) to generate returns for the counterparty. The latter is generally known as a “sale and leaseback.” Sale and leaseback usually involves only one counterparty (one individual or a small group) because of the difficulty of setting up a contract with multiple unrelated parties and the original owner. However, the limitation of only one counterparty significantly reduces the ability of the original owner to reach a much wider source of capital.

Accordingly, there is a need for a method of providing a system and method to effectively achieve a “sale and leaseback” with multiple (potentially unrelated) investors, combining the benefit of an established revenue stream from a contract and a wide source of capital from multiple (potentially unrelated) investors. Since multiple (potentially unrelated) investors would hold equity interests in the entity, there is a need for an entity officer for the operation and day-to-day decision-making of the entity (in the initial stage for capital raising until potential subsequent replacement) and therefore there is also a need for a method of providing an investor-voting system in case a voting majority of investors decide to replace the entity officer at some time after the initial stage.

### DESCRIPTION OF THE RELATED ART

Certain aspects of the three separate areas of (a) setting up a business entity to issue equity and/or debt securities to raise capital from investors, (b) using an online marketplace to match what funding-seeker/issuer offers and what investor seeks, and (c) using “sale and leaseback” as a way to raise capital for the original owner are known in the art. However, prior art regarding Area (a) generally describes consolidating different properties into one single fund-raising entity for economies of scale; prior art regarding Area (b) generally describes an online match-making system to help connect what issuer currently offers (e.g. information details of existing property) and what investor wants (e.g. requisite yield and quality of investment returns); and prior art regarding Area (c) generally describes the different types of “sale and leaseback” methods for potentially optimal accounting treatment.

Prior art applications, therefore, do not provide a solution for the original owner of a business or property to raise capital from multiple (potentially unrelated) investors with minimal involvement of “third parties” (i.e. other than the original owner and the investors) which is the key of the present invention: prior art regarding Area (a) describes the economy of scale in capital raising of consolidating multiple (potentially unrelated) issuers instead of the present invention's enabling a single issuer (the original owner of a business or property) to raise capital from multiple (potentially unrelated) investors by using a business entity to issue equity and/or debt securities and a contract (potentially involving the original owner) to generate revenue for the entity to service the payments for such securities; prior art regarding Area (b) describes an online matching-making system to help connect issuers and investors while one part of the present invention, the part regarding the business entity's issuance of equity and/or debt securities, may use online or offline methods to reach potential investors; and prior art regarding Area (c) describes different types of “sale and leaseback” for potentially optimal accounting treatment while the present invention focuses on the use of “sales and leaseback” as the method to raise capital by setting up a business entity and selling all or part of the original owner's interest to the entity which issues equity and/or debt securities (to investors to fund the entity's purchase of the original owner's interest) while setting up a contract (or lease) to generate revenue for the entity to service the payments of such securities. Therefore, prior art applications do not provide the key solution offered by the present invention which enables the original owner of a business or property to raise capital from multiple (potentially unrelated) investors with minimal involvement of “third parties” (other than the original owner and the investors), potentially with the original owner also playing the role of the entity officer (who is, at least initially, responsible for the operation and day-to-day decision-making of the entity) and the contract counterparty to the entity of the contract which generates revenue to service the payments of equity and/or debt securities issued by the entity to multiple (potentially unrelated) investors. Moreover, the present invention also includes an investor-voting system which enables a voting majority of the investors to potentially replace the entity officer for the operation and day-to-day decision-making of the entity should the voting majority of the investors so desires after the initial fund raising. This investor-voting system should give investors comfort that should the entity officer act against the interest of the investors in the future, a voting majority of the investors can replace the entity officer.

### SUMMARY OF THE INVENTION

A method of raising capital via a business entity with a contract to generate revenue for the entity according to an exemplary embodiment of the present invention comprises the steps of: providing a business entity (the “Entity”); providing an officer (the “Officer”) for the operation and day-to-day decision-making of the Entity; selling all or part of the original owner (the “OO”)'s interest in a business (e.g. a restaurant) or property (e.g. a residential house) to the Entity, providing a contract (the “Contract”, e.g. a restaurant operating contract or a residential lease) to generate revenue for the Entity; raising equity and/or debt capital issued by the Entity from investors to fund the Entity's purchase of the OO's interest; and providing an investor-voting system to enable a voting majority of the investors to potentially replace the Officer.

According to an exemplary embodiment of the present invention, a computer system for providing the Entity, providing the Officer for the operation and day-to-day decision-making of the Entity, selling all or part of the OO's interest in the business or property to the Entity; providing the Contract to generate revenue for the Entity, raising equity and/debt capital issued by the Entity from investors to fund the Entity's purchase of the OO's interest; and providing an investor voting system to enable a voting majority of the investors to potentially replace the Officer comprises: a memory that stores data relating to the Entity and the Contract; a computer-readable medium comprising: an instrument calculator that determines values of the OO's interest in the business or property to be sold to the Entity, the revenues to be generated by the Contract, the values of the equity shares of the Entity, and the values of debt issued by the Entity, and also an instrument calculator to enable voting by the investors and to determine the voting results of the investor-voting system of the Entity.

In at least one embodiment, the contract involves the OO, i.e. the OO is the counterparty (or one of the counterparties) to the Entity in the Contract, e.g. the OO is the operator of the restaurant or the OO is the tenant in the residential lease.

In at least one embodiment, the OO is not the counterparty (or one of the counterparties) to the Entity in the Contract: e.g. another person, not the OO, is the operator of the restaurant or the tenant of the residential lease.

In at least one embodiment, the Officer (before replacement, if any, through the operation of the Entity's investor-voting system) is the OO.

In at least one embodiment, the Officer (before replacement, if any, through the operation of the Entity's investor-voting system) is not the OO.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a flowchart showing a method of raising capital for a business or property according to an exemplary embodiment of the present invention; and

FIG. 2 is a block diagram of a system of raising capital for a business or property according to an exemplary embodiment of the present invention.

### DETAILED DESCRIPTION OF PREFERRED EMBODIMENTS

By using the Entity and the Contract, the present invention is able to raise capital for the OO of a business or property by the Entity issuing equity and/or debt securities to multiple (potentially unrelated) investors while the Contract (e.g. restaurant operating contract or residential lease) generates revenue for the Entity to service the dividend payments for the equity securities and/or the interest payments for the debt securities. In particular, according to the present invention, the Entity is formed with at least one Officer (who may or may not be the OO) for the operation and day-to-day decision-making of the Entity; the Contract (e.g. a restaurant operating contract or a residential lease) is established between the Entity and at least one Contract Counterparty (who may or may not be the OO) to generate revenue for the Entity. Equity and/or debt securities are issued by the entity to multiple (potentially unrelated) investors, and the Entity's revenue from the Contract forms the basis to service the dividend payments for the equity securities and/or the interest payments for the debt securities. The investors of the Entity are able to vote via a voting system if a voting majority of the investors, at some point, elects to replace the Officer for the operation and day-to-day decision-making of the Entity.

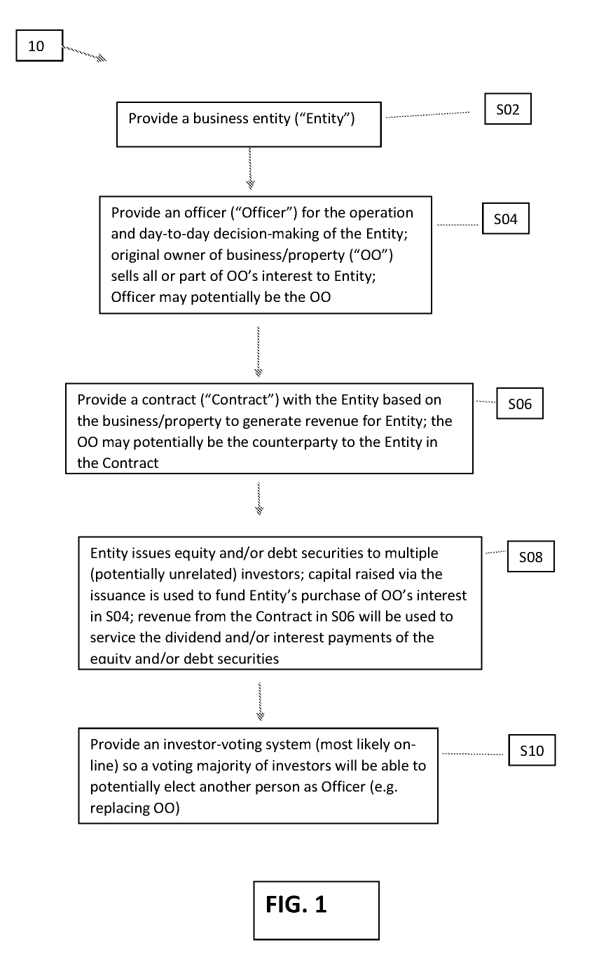

FIG. 1 is a flowchart showing a method, generally designated by reference number 10, of raising capital for a business or property according to an exemplary embodiment of the present invention. In step S02 of the method 10, a funding vehicle is provided as a C-corporation or some other form of business entity. For example, the business entity (“Entity”) may be in the form of a limited liability company (“LLC”).

In step S04 of the method 10, an officer (“Officer”) is provided for the operation and day-to-day decision-making of the Entity; the original owner (“OO”) of a business (e.g. a restaurant) or a property (e.g. a residential house) sells all or part of the OO's interest in the business or property to the Entity; the Officer may potentially be the OO.

In step S06 of the method 10, a contract (“Contract”), such as a restaurant operating contract or a residential lease, is provided to generate revenue for the Entity. The OO may potentially be the contract counterparty, e.g. the OO may potentially be the restaurant operator or lessee.

In step S08 of the method 10, the Entity issues equity and/or debt securities to multiple (potentially unrelated) investors. The capital raised is used to fund the Entity's purchase of the OO's interest in the business or property in step S04. The revenue from the Contract in step S06 will be a means to provide dividend and/or interest payments for the equity and/or debt securities.

In step S10 of the method 10, an investor voting system is set up most likely online, so a voting majority of the equity investors will be able to elect another person as the Officer replacing the OO.

### Example 1

An entity (“Entity A”) is set up. The original owner of a restaurant (“OOA”) sells all of his interest in the restaurant to Entity A, and also enters into a restaurant operating contract as restaurant operator with Entity A to generate revenue for Entity A. OOA also acts as the Officer for Entity A and is responsible for the operation and day-to-day decision-making for Entity A. Entity A issues shares to multiple (potentially unrelated) investors, using the revenue from the restaurant operating contract to service the dividend payments for the shares. Entity A also provides an on-line investor-voting system so potentially a voting majority of the investors can vote to elect another person as the Officer replacing OOA.

### Example 2

An entity (“Entity B”) is set up. The original owner of a residential house (“OOB”) sells all of her interest in the house to Entity B, and also enters into a residential lease as lessee with Entity B to generate revenue for Entity B. OOB also acts as the Officer for Entity B and is responsible for the operation and day-to-day decision-making for Entity B. Entity B issues shares to multiple (potentially unrelated) investors, using the revenue from the lease to service dividend payments for the shares. Entity B also provides an on-line investor-voting system so potentially a voting majority of the investors can vote to elect another person as the Officer replacing OOB.

### Example 3

An entity (“Entity C”) is set up. The original owner of a restaurant (“OOC”) sells all of his interest in the restaurant to Entity C, but elects not to be involved in the operation of the restaurant going forward. Instead, another person (not OOC) enters into a restaurant operating contract as restaurant operator with Entity C to generate revenue for Entity C. OOC, acts as the Officer for Entity C and is responsible for the operation and day-to-day decision-making for Entity C. Entity C issues shares to multiple (potentially unrelated) investors, using the revenue from the restaurant operating contract to service the dividend payments for the shares. Entity C also provides an on-line investor-voting system so potentially a voting majority of the investors can vote to elect another person as the Officer replacing OOC.

### Example 4

An entity (“Entity D”) is set up. The original owner of a residential house (“OOD”) sells all of her interest in the house to Entity D, but elects not to lease the property going forward. Instead, another person (not OOD) enters into a residential lease as lessee with Entity D to generate revenue for Entity D. OOD acts as the Officer for Entity D and is responsible for the operation and day-to-day decision-making for Entity D. Entity D issues shares to multiple (potentially unrelated) investors, using the revenue from the lease to service dividend payments for the shares. Entity D also provides an on-line investor-voting system so potentially a voting majority of the investors can vote to elect another person as the Officer replacing OOD.

### Example 5

An entity (“Entity E”) is set up. The original owner of a residential house (“OOE”) sells all of her interest in the house to Entity E, and another person (not OOE) enters into a residential lease as lessee with Entity E to generate revenue for Entity E. Another person (not OOE) acts as the Officer for Entity E and is responsible for the operation and day-to-day decision-making for Entity E. Entity E issues shares to multiple (potentially unrelated) investors, using the revenue from the lease to service dividend payments for the shares. Entity E also provides an on-line investor-voting system so potentially a voting majority of the investors can vote to elect another person as the Officer replacing the original Officer.

The above-described method provides a mechanism by which a business entity may raise capital for the original owner of a business or a property with minimal involvement of “third parties” (other than the original owner and the investors), potentially with the original owner also playing the role of the entity officer (who is, at least initially, responsible for the operation and day-to-day decision-making of the entity) and the contract counterparty to the entity in the contract which generates revenue to service the payments of equity and/or debt securities issued by the entity to multiple (potentially unrelated) investors in the capital raising. The method also provides an investor-voting system which enables a voting majority of the investors to potentially replace the entity officer for the operation and day-to-day decision-making of the entity should the voting majority of the investors so desires after the initial fund raising.

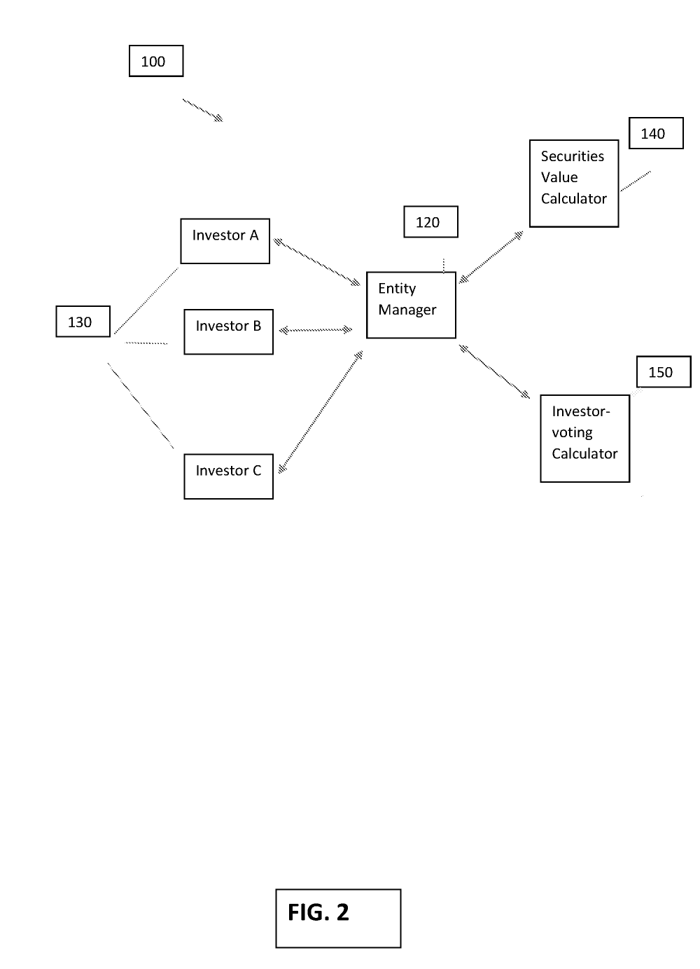

FIG. 2 is a block diagram of a system, generally designated by reference number 100, of raising capital for a business or property according to an exemplary embodiment of the present invention. The system 100 includes an entity manager 120 (who may potentially be the Officer or someone who works for or with the Officer), one or more investors 130, a securities value calculator 140, and an investor-voting calculator 150. Although only three investors are shown in FIG. 2, it should be appreciated that any number of investors may be involved in the system 100, and further the investors 130 may be individual or corporate entities.

The securities value calculator 140 determines the values of equity and/or debt securities that will be issued by the Entity to raise capital from the investors 130 to fund the Entity's purchase of the original owner (“OO”)'s interest in a business or property. The securities value calculator 140 determines the value of the equity and/or debt securities based on factors including but not limited to the projected revenue stream from the Contract, levels of interest rates, discount rates of comparable investments in the market, price to earnings ratio of comparable investments in the market, etc. Based on the values determined by the equity and/or debt securities value calculator 140, the entity manager 120 may determine the appropriate amount of equity and/or debt securities to be issued by the Entity to raise capital from the investors 130 to fund the Entity's purchase of the OO's interest.

The investor-voting calculator 150 determines the results of voting by the investors regarding the election of the Officer. The investor-voting calculator 150 determines the results of the voting by taking into account the election of the Officer by each voting investor, and the number of votes controlled by each voting investor. Based on the results determined by the investor-voting calculator 150, the entity manager will determine the identity of the Officer of the Entity,

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A method of raising capital, the method comprising: providing a business entity; providing an entity officer responsible for the operation and day-to-day decision-making of the entity; selling the original owner (OO)'s interest in a business or property to the entity; providing a contract based on the business or property to generate revenue for the entity; raising capital issued by the entity to fund the entity's purchase of the original owner's interest, and providing an investor-voting system so a voting majority of investors can replace the entity officer.

2. The method of claim 1, wherein the business entity includes a corporation.

3. The method of claim 1, wherein the business entity includes an entity that is not a corporation.

4. The method of claim 1, wherein the entity officer includes the OO.

5. The method of claim 1, wherein the entity officer includes someone who is not the OO.

6. The method of claim 1, wherein selling the OO's interest includes selling the OO's partial interest.

7. The method of claim 1, wherein selling the OO's interest includes selling the OO's entire interest.

8. The method of claim 1, wherein the contract based on the business or property includes a business operating contract such as a restaurant operating contract

9. The method of claim 1, wherein the contract based on the business or property includes a lease on a property such as a lease on a residential house.

10. The method of claim 1, wherein the contract includes a contract in which the OO is a counterparty of the contract.

11. The method of claim 1, wherein the contract includes a contract in which the OO is not a counterparty of the contract.

12. The method of claim 1, wherein the revenue includes revenue generated from a business operating contract such as a restaurant operating contract.

13. The method of claim 1, wherein the revenue includes revenue generated from a lease on a property such as a lease on a residential house.

14. The method of claim 1, wherein the capital raised by the entity includes capital raised by the issuance of equity.

15. The method of claim 1, wherein the capital raised by the entity includes capital raised by the issuance of debt.

16. The method of claim 1, wherein the investor-voting system includes an on-line system.

17. The method of claim 1, wherein the investor-voting system includes an off-line system.
